(19) United States
(12) Patent Application Publication
(10) Pub. No.: US 2010/0114871 A1
(43) Pub. Date: May 6, 2010

(54) Distance Quantization in Computing Distance in High Dimensional Space

(75) Inventors: Hye-Yeon Cheong, Burbank, CA (US); Antonio Ortega, Los Angeles, CA (US)

Correspondence Address: FISH & RICHARDSON, PC, P.O. BOX 1022, MINNEAPOLIS, MN, 55440-1022, US

(73) Assignee: University of Southern California

(21) Appl. No.: 12/611,037

(22) Filed: Nov. 2, 2009

Related U.S. Application Data
(60) Provisional application No. 61/110,472, filed on Oct. 31, 2008.

(51) Int. Cl. G06F 17/30

(52) U.S. Cl. 707/719; 707/E17.01

(57) ABSTRACT

Techniques and systems for quantization based nearest neighbor searches can include quantizing a set of candidate points based on one or more characteristics of a query point; generating metric values based on the quantized candidate points, respectively, the metric values being indicative of respective proximities between the query point and the candidate points; and selecting one or more of the candidate points in response to the query point based on the metric values. In some implementations, techniques and systems can compress search metric computation resolution by implementing non-uniform scalar quantization within a metric computation process.

### PRIORITY CLAIM AND CROSS REFERENCE TO RELATED APPLICATION

This document claims the benefit of U.S. Provisional Application No. 61/110,472 entitled “Distance Quantization in Computing Distance in High Dimensional Space” and filed on Oct. 31, 2008, which is incorporated by reference as part of the disclosure of this document.

### FEDERALLY SPONSORED RESEARCH OR DEVELOPMENT

This invention was made with government support under 0428940 awarded by the National Science Foundation (NSF). The government has certain rights in the invention.

### BACKGROUND

This document relates to nearest neighbor search techniques and their implementations based on computer processors.

Various applications perform nearest neighbor searches to locate one or more points closest to an input point, such as a query point. Nearest neighbor searches can include locating a data point inside a data set S in metric space M that is closest to a given query point q ε M based on a distance metric d:q×S→ [symbol] . In some cases, metric space M is the k-dimensional Euclidean space [symbol] ^{k} . The nearest neighbor for a point is given by:

NN(q)={ x̅ ε S|∀x ε S ⊂ M, q ε M:d( x̅,q)≦d(x,q)}.

A distance metric can measure a proximity of one point to another point. One example of a distance metric is the Minkowski metric. A Minkowski metric of order p, also known as the p-norm distance, measures a distance between two k-dimensional data points q and x. The Minkowski metric is defined as:

$$d ( q , r ) = {‖ q - r ‖}_{p} = {( {\sum }_{j = 1}^{k} {\vert {q}_{j} - {r}_{j} \vert}^{p} )}^{1 / p} .$$

Performing a metric computation can include calculating a value based on the Minkowski metric. For example, a metric computation can include performing a distance computation in each dimension to compute respective dimension-distances: distⱼ(q,r)=|qⱼ−rⱼ|^{p} performing a summation of all such distances:

$${\sum }_{j = 1}^{d} {dist}_{j} ( q , r ) ,$$

and performing a 1/p-th power computation on an output of the summation to produce an output.

### SUMMARY

This document describes, among other things, technologies that perform quantization based nearest neighbor searches.

Techniques for quantization based nearest neighbor searches can include quantizing a set of candidate points based on one or more characteristics of a query point; generating metric values based on the quantized candidate points, respectively, the metric values being indicative of respective proximities between the query point and the candidate points; and selecting one or more of the candidate points in response to the query point based on the metric values. Other implementations can include corresponding systems, apparatus, and computer programs, configured to perform the actions of the methods, encoded on computer storage devices.

These and other implementations can include one or more of the following features. Implementations can compress search metric computation resolution based on non-uniform scalar quantization within a metric computation process. Quantizing the candidate points can include accessing non-uniform intervals based on the query point, each non-uniform interval being described by one or more threshold values and associated with a range of inputs and an output, and quantizing the candidate points based on non-uniform intervals. The query point and the candidate points can include elements that correspond to respective dimensions. Quantizing the candidate points can include using different sets of non-uniform intervals, associated with respective different ones of the dimensions, to quantize the dimensional elements of the candidate points, each set of non-uniform intervals selected based on a respective element of the query point. Generating metric values based on quantized candidate points can include summing quantized elements of a quantized candidate point to produce a metric value. Implementations can include performing motion estimation based on information including the selected one or more candidate points.

Implementations can include determining one or more quantizers that preserve distance ranking between the query point and the candidate points. Quantizing the candidate points based on one or more characteristics of the query point can include using the one or more quantizers. Quantizing the candidate points based on one or more characteristics of the query point can include using different quantizers, associated with different dimensions, to quantize elements. Determining one or more quantizers can include determining a number of quantization levels, one or more quantization threshold values, and mapping values for one or more dimensions.

Implementations can include determining one or more statistical characteristics of multiple, related, query points; the query points can include elements that correspond to respective dimensions. Implementations can include determining one or more quantizers based on the one or more statistical characteristics, each quantizer corresponding to at least one of the dimensions and operable to generate a quantized output based on an input. Quantizing the candidate points based on one or more characteristics of the query point can include using the one or more quantizers. Determining one or more quantizers can include determining a quantizer that maps successive bins of input values to respective integer values. Determining one or more quantizers can include determining threshold values that delineate non-uniform quantization intervals based on an iterative process that minimizes a nearest neighbor search measure.

In another aspect, techniques can include accessing a set of candidate points from a memory; and operating processor electronics to perform operations based on the set of candidate points with respect to a query point to produce values being indicative of respective proximities between the query point and the candidate points, and use the values to determine a nearest neighbor point from the set of candidate points. The computations include applying non-uniform quantizations based on one or more characteristics of the query point. Other implementations can include corresponding systems, apparatus, and computer programs, configured to perform the actions of the methods, encoded on computer storage devices.

These and other implementations can include one or more of the following features. Applying non-uniform quantizations can include quantizing the candidate points based on non-uniform intervals. Non-uniform intervals can be described by a set of threshold values that are based on the query point. Each one of the quantized candidate points can include quantized elements corresponding to a plurality of dimensions. Operating processor electronics to perform operations can include operating processor electronics to sum quantized elements of a corresponding one of the quantized candidate points to produce a corresponding one of the values. The query point can include elements corresponding to a plurality of dimensions. Candidate points can include elements corresponding to the plurality of dimensions. Operating processor electronics to perform operations can include operating processor electronics to generate, for two or more of the dimensions, a partial distance term that is indicative of a distance between corresponding elements of the query point and each one of the candidate points. Operating processor electronics to perform operations can include operating processor electronics to quantize the partial distance terms based on the non-uniform intervals. Operating processor electronics to perform operations can include operating processor electronics to determine a metric value based on a summation of the quantized partial distance terms associated with the each one of the candidate points. Partial distance terms can include dimension-distance terms. Quantizing can reduce a bit-depth of each dimension-distance term.

In another aspect, apparatuses and systems can include a memory configured to store data points and processor electronics. Data points can include elements that correspond to respective dimensions. Processor electronics can be configured to access a query point, use one or more of the data points as candidate points, use one or more quantizers to quantize the candidate points based on one or more characteristics of the query point, generate metric values based on the quantized candidate points, respectively, the metric values being indicative of respective proximities between the query point and the candidate points, select one or more of the candidate points, based on the metric values, as an output to the query point.

Particular embodiments of the subject matter described in this document can be implemented so as to realize one or more of the following advantages. Quantization based metric computations based on non-uniform quantization can preserve nearest neighbor search rankings Applying non-uniform quantization to candidate points can maintain distance rankings

Quantization based metric techniques can provide reduced complexity for metric computations. In some implementations, the number of computationally expensive arithmetic processes such as those associated with calculating non-quantized dimension-distances can be reduced. Complexity of one or more additional arithmetic processes associated with a metric computation can be reduced. Quantization based metric techniques can be implemented such that complexity does not increase with the order of the 1ₚ norm. In some implementations, quantizing the output of each dimension-distance computation into 1-bit outputs can significantly reduce implementation complexity and its performance tends to be nearly unchanged for several applications because some dimension-distances tend to exhibit very compact low-variance statistical characteristics. Implementations can use one or more data sets or dimension reduction techniques to provide additional complexity reduction.

Quantization based metric techniques can be implemented with one or more applications such as video processing, vector quantization, information retrieval, pattern recognition, optimization tasks, and computer graphics. For example, quantization based metric techniques can be implemented to find similar images in a database. Video coding applications can use quantization based metric techniques for various tasks such as motion estimation and compensation for video coding. For example, without using any filtering, transform, or sorting process, one or more embodiments based on the described techniques and systems can provide on average 0.02 dB loss using only 1 bit per dimension instead of 8 bits and 0.0 dB loss when 2 bits are used.

The details of one or more embodiments of the subject matter described in this document are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B show different examples of non-uniform quantization within a metric computation technique.

FIGS. 2A and 2B show examples of various circuitry in some metric computation implementations.

FIGS. 3A and 3B show examples of complexity behaviors for different metric computation techniques based on input bit size.

FIGS. 4A, 4B, and 4C show examples of comparisons of complexity-performance trade-offs for four different scenarios.

FIGS. 5A and 5B show examples of comparisons between different cost functions.

FIG. 6 shows examples of different techniques performances as a function of quantization thresholds.

FIGS. 7A and 7B show examples of different techniques performances as a function of bit rate.

FIGS. 8A, 8B, and 8C show example performance measures using different image sequences.

FIG. 8D shows examples of different computational complexity costs.

FIG. 9 shows an example of a quantization based on a nearest-neighbor-preserving metric approximation technique.

FIGS. 10A and 10B show examples of metric computation architectures that include one or more quantizers.

FIG. 11 shows an example of a system configured to perform non-uniform quantized based metric computations.

FIG. 12 shows an example of a process that includes non-uniform quantized based metric computations.

Like reference symbols and designations in the various drawings indicate like elements.

### DETAILED DESCRIPTION

Searching for nearest neighbors in high dimensional spaces is important to a wide range of areas and related applications including statistics, pattern recognition, information retrieval, molecular biology, optimization tasks, artificial intelligence, robotics, computer graphics, and data compression. Various real world applications perform searches in high dimensional search spaces with often highly varying non-deterministic data sets, which can lead to increased exponential complexity in search computations. Thus, finding the nearest neighbor in high dimensional space can pose serious computational challenges due to factors including the size of the data point set such as a database, dimensionality of the search space, and metric complexity. For example, computational complexity associated with some nearest neighbor implementations can be high due to high dimensional space searches.

Some nearest neighbor techniques reduce complexity based on altering the data set while computing a distance metric to full precision. Some techniques are based on using partial information, e.g., a data set S can be altered so that only parts of the database are searched or only part of the query data is used for matching. For example, some techniques search only a subset of candidate vectors. In another example, some techniques reduce search space dimensionality. Some nearest neighbor techniques can alter the data set S by using algorithms such as data-restructuring, filtering, sorting, sampling, transforming, bit-truncating, quantizing and can blindly compute a given metric to full resolution for a dissimilarity comparison based on such alterations data to locate the minimum distance data point.

This document describes, among other things, techniques and systems to perform fast nearest neighbor search computations. The described techniques and systems can provide significant reduction in complexity based on preserving the fidelity of the minimum distance ranking instead of the data set S, and selectively reducing the search metric computation resolution—instead of blindly computing a metric to full resolution. In some implementations, a metric value is computed only in order to compare different candidate points, and thus the metric value itself is not important, as long as the metric value provides relative information that permits a metric technique to identify the candidate closest to the query point. A query point can be represented as a query vector. The described techniques and systems can apply non-uniform quantization based one or more characteristics of a query point to reduce search metric computation resolution in such a way that the minimum distance ranking is most likely to be preserved. The techniques and systems can use one or more quantizers optimized to minimize the impact of quantization on identifying the nearest neighbor.

A nearest neighbor search process can include accessing a query point and a set of candidate points. The process can quantize the candidate points based on one or more characteristics of the query point. The process can calculate metric values based on the quantized candidate points. In some implementations, the metric values are indicative of respective proximities between the query point and the candidate points. The process can output one or more of the candidate points in response to the query point based on the metric values. In some implementations, the output can include the identities of one or more candidate points in a distance rank order.

Various nearest neighbor search processes can use a quantization based metric computation method. For example, metric techniques can apply quantization to one or more aspects of a Minkowski metric. A quantized metric can be based on a quantized form of a Minkowski metric. A quantized metric can include a quantization function such as Qⱼ and Q̅′ⱼ For example, a quantized metric d̅ can be represented as:

$$\overline{d} ( q , r ) = {( {\sum }_{j = 1}^{k} {Q}_{j} ( {\vert {q}_{j} - {r}_{j} \vert}^{p } ) )}^{1 / p } .$$

In yet another aspect, a quantized metric d̅ can be represented as:

$$\overline{d} ( q , r ) = {( {\sum }_{j = 1}^{k} {\overline{Q}}_{j}^{′} ( {r}_{j} ) )}^{1 / p} .$$

The above two equations including Qⱼ and Q̅″ⱼ, respectively, may have similar, if not identical, computational performance. A quantizer can be configured to quantize the output of a dimension-distance |qⱼ−rⱼ|^{p}. Such a quantizer can provide a reduced bit-depth of each dimension-distance output which can lead to a significant complexity reduction in metric processes such as in a tree of k−1 summations and in a 1/p-th power computation. In some implementations, a quantizer can be implemented such that the input dimension-distance computation |qⱼ−rⱼ|^{p} does not have to be computed at all. In some cases, quantizer thresholds can be fixed over multiple queries and a given query point, q, being constant over searching many different candidate points, e.g., different r. In some implementations, a quantizer can be configured to directly quantize candidate points. For example, candidate points can be quantized directly without having to compute |qⱼ−rⱼ|^{p} first and then to apply quantization.

The quantization function Qⱼ represents quantization on a j-th dimensional input and uses a threshold set such as {θⱼᵢ}₁₌₁^{N-1}. The quantization function Q̅″ⱼ uses a threshold set such as {qⱼ±θⱼᵢ^{1/p}}ᵢ₌₁^{N-1}. Compared to Qⱼ, Q̅″ⱼ uses twice as many thresholds even though computation of |qⱼ−rⱼ|^{p} is not required. In some implementations, quantization using Q̅″ⱼ can be performed using a table-lookup method to increase performance. In some implementations, the inversion operation and the p-th power operation associated with a metric function can be replaced with operations that compare a value with one or more thresholds. In some implementations, a quantization function can use a threshold set such as {sign(qⱼ−rⱼ)·θⱼᵢ^{1/p}}ᵢ₋₁^{N 1} or {±θⱼᵢ^{1/p}}ᵢ₋₁^{N 1}.

Quantization based metric computation can reduce associated computational complexity. In some implementations, this result in reduced complexity in one or more calculations of a metric computation. In some implementations, such a complexity reduction may come with some performance loss due to possible information loss caused by a quantization process. For example, coarser quantizer may increase the complexity reduction ratio while it may lead to an increased information loss.

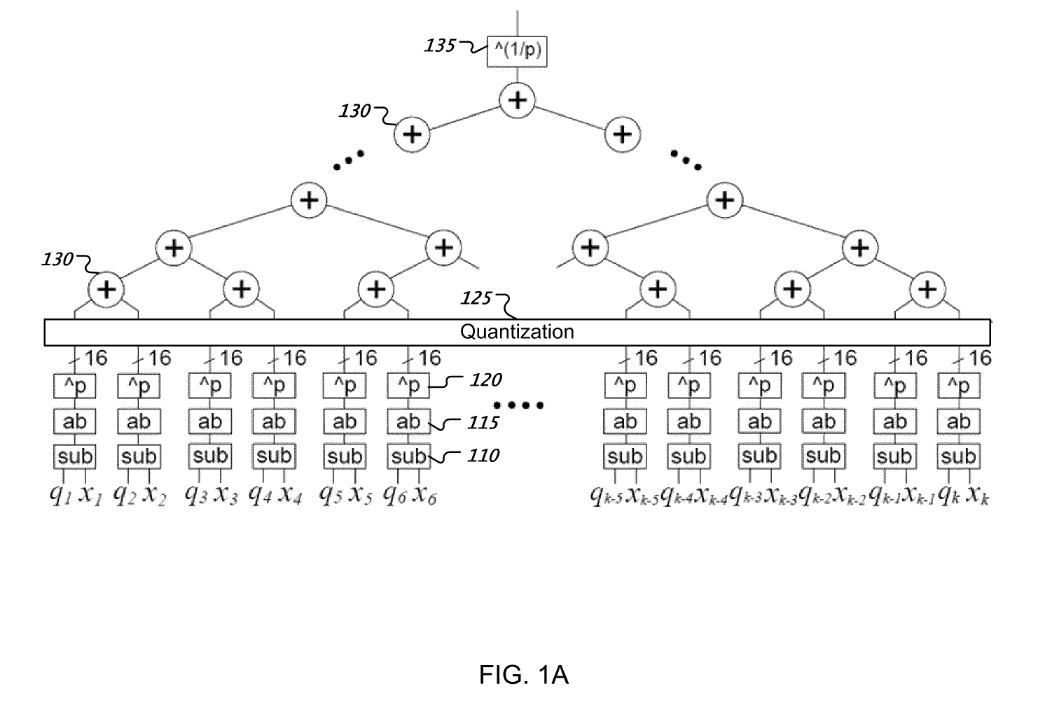

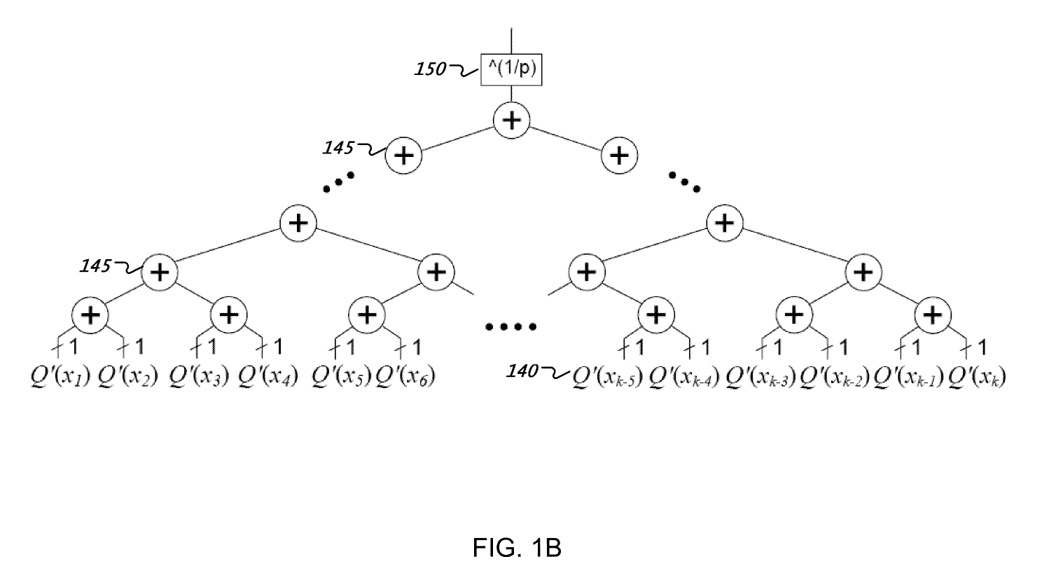

FIG. 1A shows an example of non-uniform quantization within a metric computation technique. In this example, a metric computation technique, such as one based on a Minkowski metric, can measure the dissimilarity between two k-dimensional data points q and x. The metric computation technique can include computing partial distance terms such as dimension-distance terms, e.g., distⱼ(q,x)=|1ⱼ−xⱼ|^{p}, for each dimension by performing operations such as subtracting 110, taking the absolute value 115, and rising to the p-th power 120.

The metric computation technique can include applying non-uniform scalar quantization 125 on the partial distance terms to produce quantized partial distance terms. Applying non-uniform scalar quantization 125 can include using a set of integer values that are assigned to respective intervals that cover possible input values. For example, a partial distance term value that falls into a specific interval can be assigned the integer value corresponding to that specific interval. Hence, the quantized partial distance value can be the corresponding integer value. are not required to be uniform. The set of intervals can be non-uniform, e.g., one interval has a larger span than another interval. The metric computation technique can sum over the quantized partial distance terms using a network of one or more summations 130. The metric computation technique can perform a 1/p-th power computation 135 on an output of the summation(s) to produce an output. In some implementations, non-uniform scalar quantization 125 can include using a quantizer that is chosen to preserve a minimum distance ranking

FIG. 1B shows a different example of non-uniform quantization within a metric computation technique. In this example, a metric computation technique, such as one based on a Minkowski metric, can measure the dissimilarity between two k-dimensional data points q and x. The metric computation technique can apply a non-uniform scalar quantization 140 on each of the dimensional values for the point x, which is represented by Q′(xᵢ). The quantization function can be different for one or more of the dimensions. For example, each dimensional value can be quantized using different sets of intervals and different assigned values to the intervals. In some implementations, the selection of intervals is based on a query point which is represented by q in this example. Applying non-uniform scalar quantization 140 can transform a n-bit value representation into a 1-bit quantized value representation. The quantized outputs can be summed via one or more summations 145. The metric computation technique can perform a 1/p-th power computation 150 on an output of the summation(s) network to produce an output. In some implementations, non-uniform scalar quantization 140 can include using a quantizer that is chosen to preserve a minimum distance ranking.

In one aspect, non-uniform scalar quantization can be applied within a metric computation process. In various implementations, this approach can be used to achchieve significant complexity savings by reducing the number of operations such as a total number of additions and complexity such as an adder bit depth of required arithmetic operations. Moreover, these computational savings can have minimal impact on performance because quantization processes can preserve the minimum distance ranking fidelity. In some implementations, metric computation processes can include non-uniform scalar quantization and one or more techniques that modify a candidate data set S.

Computational complexity, computation-related power consumption and circuit size of most arithmetic elements such as adder or multiplier can depend on an input bit depth. Computational complexity tends to increase linearly or exponentially with the number of input bit lines in various circuitry for executing such computations. A dimension-distance computation that includes performing |qⱼ−rⱼ|^{p} can result in n·p bit depth output, where inputs qⱼ and rⱼ are represented by n-bit numbers (e.g., n=8, 16, 32, and 64 bits). A metric value can be computed by summing the distances computed in each dimension. Circuitry to implement such a summation can include k−1 multiple-bit adders with maximum bit depth of n·p+┌log₂ k┐.

Various implementations of the described subject matter can reduce computational complexity associated with nearest neighbor searches at the circuit level. The input bit-depth of each arithmetic element can be incorporated into a complexity analysis.

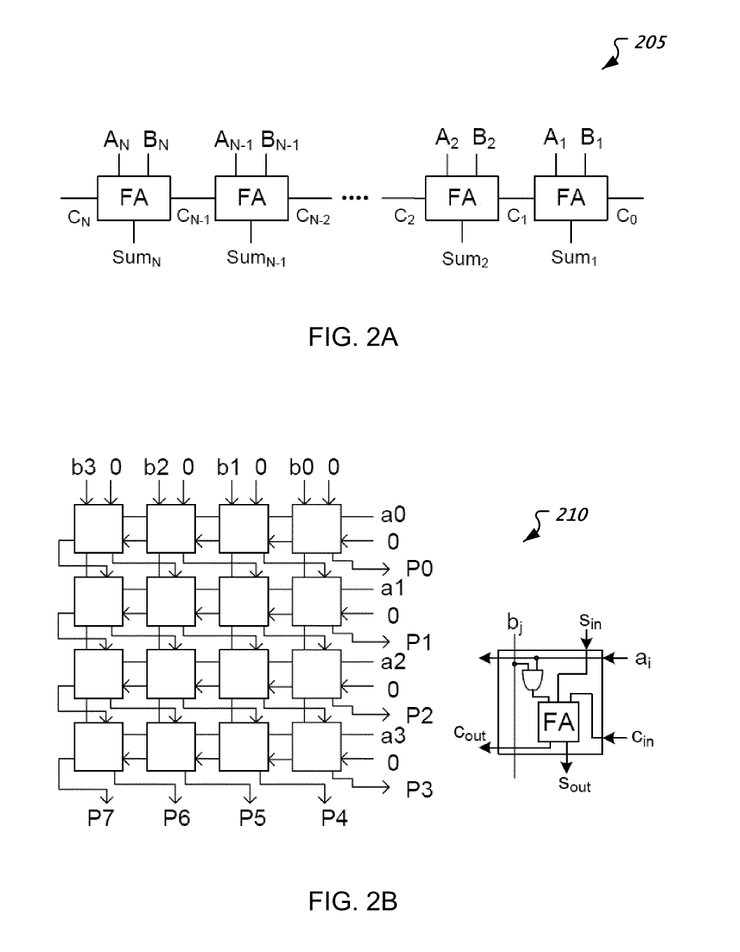

FIGS. 2A and 2B show examples of various circuitry in some metric computation implementations. FIG. 2A shows an example of an adder circuit 205. FIG. 2B shows an example of a multiplier circuit 210. The size of the arithmetic circuit such as adder or multiplier circuits may increase with an input bit size. For example, computational complexity, circuit size, static and dynamic power consumption, computation delays of most basic arithmetic elements including adder or multiplier can be influenced by, and increase polynomially with, the input bit size. Therefore, quantization applied to partial distance terms in each dimension, e.g., as shown in FIG. 1a, can significantly reduce complexity associated with a summation process. In some applications such as video coding, very coarse quantization is possible (e.g., to 1 bit), which can result in reduced complexity in a summation process while leaving video coding performance nearly unchanged.

Metric computations can use quantizers that eliminate a per dimension distance computation |qⱼ−xⱼ|^{p}, e.g., an implementation based on the architecture shown in FIG. 1B. In some cases, the quantizer thresholds }θᵢ} and the query vector q are fixed for a given search query, so that only the x ε S being tested for their proximity to q vary. Therefore, candidate data x can be quantized directly with a quantizer Q′: {q±θᵢ^{1/P}}, which can lead to the same result as computing |qⱼ−xⱼ |^{P} followed by quantization by Q: {θᵢ}, but at a fraction of the complexity.

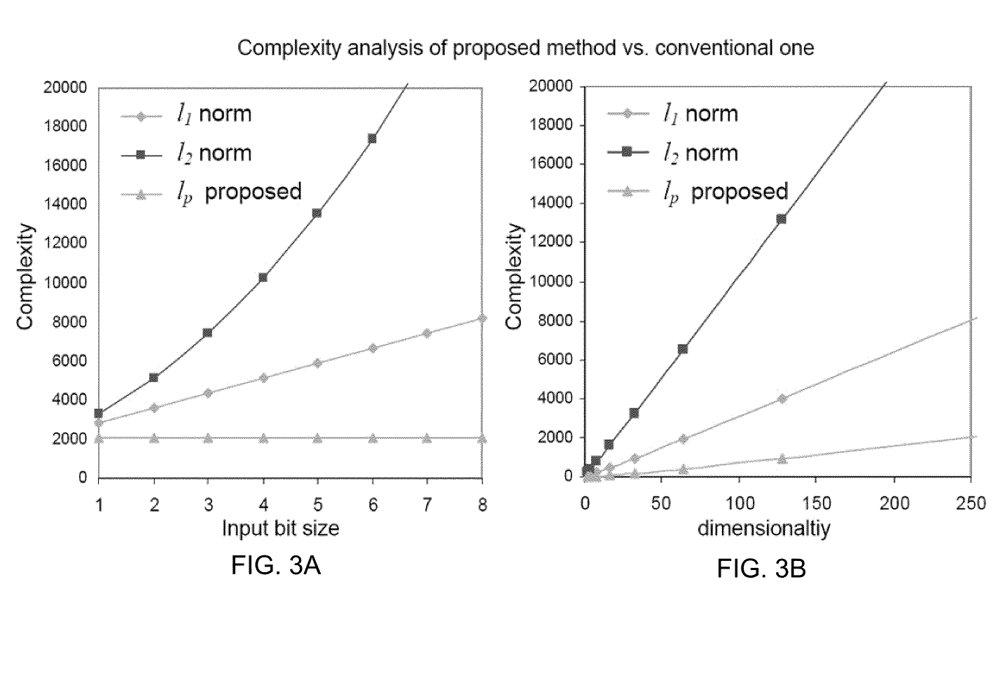

FIG. 3A shows an example of complexity behaviors for different metric computation techniques based on input bit size. FIG. 3B shows an example of complexity behaviors for different metric computation techniques based on dimensionality. In these examples, the metric computation techniques include conventional l₁ and l₂ norm metric computations and a proposed distance quantization based lₚ norm metric computation. FIGS. 3A and 3B show that complexity increases as a function of the input bit size, dimensionality, and order p of metric (p-norm distance) for both conventional and proposed metric computations. Complexity can be measured, for example, in units of number of full-adder operations, e.g., basic building blocks of arithmetic logic circuits, under the assumption that n-bit addition, subtraction, and absolute value operations have the same complexity and that a square operation has equivalent complexity to that of an n²-bit addition. For a motion estimation example, the dimensionality represents the number of pixels per matching block and the input bit size represents pixel bit-depth. In these examples, the complexity of the proposed distance quantization remains constant over different input bit sizes and lₚ norms, while the complexity slowly increases with dimensionality as compared to the conventional metric computations.

A quantized metric computation process can use an output of a quantizer optimization technique that determines one or more optimal quantizers. A quantizer optimization technique can include using a cost function to quantify the difference in performance between an arbitrary search algorithm and a chosen benchmark search algorithm. A cost function can be based on computing the average difference in distance between a query point and the, possibly different, nearest neighbors identified by each algorithm. The search dataset, a query, a metric, and a resulting nearest neighbor data point of a benchmark algorithm are represented by S, q, d, and NN(q), respectively. Here,

NN(q)={ x̅ ε S|∀x ε S ⊂ M,q ε M:d( x̅,q)≦d(x,q)}.

The search dataset, a query, a metric, and a resulting nearest neighbor data point of a target algorithm are represented by S̅, q̅, d̅, and N̅N̅(q) similar, respectively. Here,

N̅N̅(q)={ x̅ ε S̅|∀x ε S̅⊂ S,q ε M: d̅( x̅, q̅)≦ d̅(x, q̅)}

A nearest neightbor cost function, E_{NN}, can be written as:

E_{NN}=E{d( N̅N̅(q),q)−d(NN(q),q)}.

E_{NN} can represent an average NNS error measure. In some implementations, the expectation E is with respect to the query data when S and S̅ are fixed. In some implementations, the expectation E is with respect to the set {(q,S, S̅)ᵢ}ᵢ. The cost function can be further expressed as:

E_{NN}=∫_{R}_{^{−}} μ̅(a) f̅(a)da−∫_{R}_{⁺}a f(a)da

where μ̅(a)=E{d(x,q)| d̅(x,q)=a,x ε S̅}, and minimum distance distribution functions f̅(a)=Pr( d̅( N̅N̅(q),q)=a), f(a)=Pr(d(NN(q),q)=a).

In some implementations, only the first terms in the equations for E_{NN} are considered because the target algorithm affects the first term and not the second term. Therefore, a cost function can be expressed as Ē=E {d( N̅N̅(q),q)}=∫_{R}_{⁺} μ̅(a) f̅(a)da.

In some implementations, techniques and systems do not modify a data set S or a query point q, but instead use a quantizer within the Minkowski metric computation. Thus, the Minkowski metric can be used as a benchmark with S̅=S to find a quantizer that, for a given number of quantization levels N, can minimize E_{NN}. Instead of considering statistical information of x ε S and q separately, a cost function can be based on statistical characteristics of Y, a k -dimensional multivariate random variable representing the input data on which a quantizer is applied:

Yᵢ=(yₙ, y₁₂, . . . , yᵢₖ)=(|q₁−xᵢ₁|^{p},|q₂−xᵢ₂|^{p}, . . . , qₖ−xᵢₖ|^{p}).

Quantized input can be described as:

Zᵢ=(zᵢ₁, zᵢ₂, . . . , zᵢₖ)=Q(Y)=(q(yᵢ₁),Q(yᵢ₂), . . . , Q(yᵢₖ)).

Corresponding benchmark and proposed target metrics are:

$$d ( {Y}_{i} ) = {( {\sum }_{j = 1}^{k} {y}_{ij} )}^{1 / p}$$

$$\overline{d} ( {Y}_{i} ) = d ( Q ( {Y}_{i} ) ) = {( {\sum }_{j = 1}^{k} {z}_{ij} )}^{1 / p} .$$

The number of candidates M and their dimensions k can be assumed to be fixed over the search process. A quantizer operating on y as a set of N non-overlapping intervals that cover all possible values of y: S={sₙ;sₙ=[θₙ,θₙ₊₁),n ε Φ56 , where Φ is a set of consecutive integers from 0 to N-1, and {θₙ} is an increasing sequence of thresholds. Therefore, for all Yᵢⱼ ε sₙ, we assign zᵢⱼ=Q(yᵢⱼ)=n, and the probability mass function (pmf) pᵢⱼ and centroid of μᵢⱼ of zᵢⱼ can be computed using f_{y}_{ᵢⱼ}, the probability density function (pdf) of yᵢⱼ as:

$${z}_{ij} = Q ( {y}_{ij} ) = {\sum }_{n} n {1}_{{s}_{n}} ( {y}_{ij} ) , \\ {p}_{ij} ( n ) = {\int }_{{s}_{n}} {f}_{{y}_{ij}} ( y ) d y , and$$

$${μ}_{ij} ( n ) = \frac{{\int }_{{s}_{n}} {yf}_{{y}_{ij}} ( y ) d y}{{\int }_{{s}_{n}} {f}_{{y}_{ij}} ( y ) d y} .$$

The cumulative mass and centroid functions of zᵢⱼ is denoted as

$${P}_{ij} ( n ) = {\sum }_{{s}_{0}}^{{s}_{n}} {p}_{ij} ( n )$$

$$and$$

$${U}_{ij} ( n ) = {\sum }_{{s}_{0}}^{{s}_{n}} {p}_{ij} ( n ) {μ}_{ij} ( n ) .$$

A simple case with M random samples from a k-variate distribution f_{Y} with iid dimensions, i.e., all yⱼ following the same pdf f_{y} and are independent of each other. The k-dimensional space can be partitioned into hypercubes through quantization, so that each input sample Y=(y₁,y₂, . . . , yₖ) falls into one of the hypercubes. Each hypercube can be represented by a vector Z=(z₁,z₂, . . . , zₖ)=(_{Q}(y₁),Q(y₂), . . . , Q(yₖ)) and all zⱼ have the same pmf p and the same centroid function μ. Each hypercube Z can be described by i) a probability mass M_{z}, ii) a centroid C_{z}, and iii) its corresponding total metric S_{z}:

$${M}_{Z} = {\prod }_{j} p ( {z}_{j} ) , {C}_{Z} = {\sum }_{j} μ ( {z}_{j} ) , {S}_{Z} = {‖ Z ‖}_{1} = {\sum }_{j} {z}_{j} .$$

The pmf P_{∥z∥}_{₁} represents the probability of a sample Y falling in one of the hypercubes having a given S_{z}:

$${p}_{{‖ Z ‖}_{1}} ( x ) = {\sum }_{{‖ Z ‖}_{1} = x} {M}_{Z} = {\sum }_{{‖ Z ‖}_{1} = x} \prod p ( {z}_{j} ) = {p}^{* k} ( x ) ,$$

where p*^{k} is the k-fold power convolution of p. Some implementations can minimize the cost function

$$\overline{E} \text{:} \overline{E} = {\sum }_{a} \overline{μ} ( a ) \overline{p} ( a ) ,$$

where p̅ is the pmf of the minimum S_{z} value among M samples of Y:

$$\overline{p} ( a ) = {( {\sum }_{x = a}^{∞} {p}_{{‖ Z ‖}_{1}} ( x ) )}^{M} - {( {\sum }_{x = a + 1}^{∞} {p}_{{‖ Z ‖}_{1}} ( x ) )}^{M} , \\ and$$

$$\overline{p} = ∇ {( {\hat{P}}_{{‖ Z ‖}_{1}} ( a ) )}^{M} ,$$

where ∇ is a backward difference operator and we define a reverse cmf \hat{P}(x)=1−P(x)=Pr[X≧x]. μ̅(a) is the centroid of all hypercubes with the same S_{z}=a.

$$\overline{μ} ( a ) = \frac{{\sum }_{{‖ Z ‖}_{1} = a} {M}_{Z} {C}_{Z}}{{\sum }_{{‖ Z ‖}_{1} = a} {M}_{Z}}$$

$$\overline{μ} = \frac{{kp}^{* ( k - 1 )} * ( p μ )}{{p}^{* k}} .$$

The above formulation assumes p=1. Alternatively, it would be valid for cases when the benchmark metric does not include 1/p -th power computation, as is the case in most real search applications. Otherwise, redefining C, as

$${C}_{Z} = {( {\sum }_{j} μ ( {z}_{j} ) )}^{\frac{1}{p }}$$

allows the same procedure to be used.

Extending this to the more general case, candidates Yᵢ can be considered to be drawn each from different f_{Y}_{ᵢ}. Similarly, each vector dimension can have non-identical distributions. However, vector data is independent across dimensions and candidates with similar distance in terms of the benchmark metric d also share a similar distribution. The following function f_{λ}(λ)=Pr(d(x,q)=λ,x ε S), a distribution of M candidates Yᵢ can be denoted in terms of benchmark distance (λ). Representing candidates having same λ as Y_{λ}=(y_{λ1},y_{λ2}, . . . , y_{λk}) with y_{λj}, following a pdf f_{y}_{_{λj}}, provides Z_{λ}=(z_{λ1},z_{λ2},z_{λk}) with z_{λj} following a pmf p_{λj} and its centroid function μ_{λj}. Thus, for each hypercube Z_{λ},

$${M}_{{Z}_{λ }} = {\prod }_{j} {p}_{λ j} ( {z}_{λ j} )$$

$${C}_{{Z}_{λ}} = {\sum }_{j} {μ}_{λ j} ( {z}_{λ j} )$$

$${S}_{{Z}_{λ}} = {‖ {Z}_{λ} ‖}_{1} .$$

A new operator

$${\prod }_{i = n}^{m} {p}_{i}^{*} ≡ {p}_{n} * {p}_{n + 1} * … * {p}_{m}$$

with which can be represented p_{∥z}_{_{λ}}_{∥}_{₁} as,

$${p}_{{‖ {Z}_{λ} ‖}_{1}} ( x ) = {\sum }_{{‖ {Z}_{λ} ‖}_{1} = x} {M}_{{Z}_{λ}}$$

$${p}_{{‖ {Z}_{λ} ‖}_{1}} = {\prod }_{j = 1}^{k} {p}_{λ j}^{*} .$$

Consequently, p̅ and μ̅ of Ē=Σ_{d} μ̅(a) p̅(a) becomes

$$\overline{p} = ∇ {( {E}_{λ} [ {\hat{P}}_{{‖ {Z}_{λ} ‖}_{1}} ( x ) ] )}^{M} , \\ and$$

$$\overline{μ} = {E}_{λ} [ {\sum }_{i = 1}^{k} ( {\prod }_{j \neq i}^{1 … k} {p}_{λ j}^{*} ) * ( {p}_{λ i} {μ}_{λ i} ) / {p}_{{‖ {Z}_{λ} ‖}_{1}} ] .$$

Given the cost function quantifying the performance loss, a quantizer is identified that leads to the minimum Ē. Considering the case when data is assumed to be independent identical distributed (iid) across dimensions, for a given input distribution f_{y}, a quantizer can be uniquely defined by two vectors μ, p ε [symbol] , where p satisfies the probability axioms, e.g., it is uniquely defined given the set of centroids and the probability masses of each quantization bin. Note that given f_{y}, Ē is a function of p. Note also that Ē can be represented in terms of P and U, defined previously as cumulative mass and centroid functions of zⱼ, where P ε C such that Ē(P): [symbol] [symbol] [symbol] and C is a convex subset of [symbol] , C={x|xᵢ≦xᵢ₊₁,0≦xᵢ≦1,∀i,x ε [symbol] . It can be shown that

Ē(\hat{P})≧Ē(P)+(\hat{P}−P)′∇Ē(P), ∀\hat{P},P ε C

where a gradient of

$$\overline{E} \text{:} ∇ \overline{E} ( {F}_{z} ) = {( \frac{\partial \overline{E} ( P )}{\partial P ( 0 )} , … , \frac{\partial \overline{E} ( P )}{\partial P ( N - 1 )} )}^{′} ,$$

proving that Ē is convex over C.

Finding the optimal quantizer can be formulated as a constrained convex optimization problem with the goal to minimize Ē(P) subject to P ε C. The global minimum value represents the optimal performance attainable given input distribution and can be obtained using standard convex optimization techniques. A quantizer can be determined based on the P vector corresponding to the global minimum.

The techniques and systems as described in this document can be applied to motion estimation (ME) process used in video coding system, for example. Without requiring any filtering, transform, or sorting process, using simple hardware oriented mapping, one or more embodiments of the described techniques and systems can provide on average 0.05 dB loss using only 1 bit per dimension instead of 8 bits and 0.01 dB loss when 2 bits are used, when a 1₁ norm distance was used for distance computation. In another aspect, one or more embodiments based on the described techniques and systems can provide on average 0.02 dB loss using only 1 bit per dimension instead of 8 bits and 0.0 dB loss when 2 bits are used. Similar results can be obtained for general 1ₚ distances.

Various sequences are tested for simulation using a H.264/MPEG-4 AVC baseline encoder with 16×16 block partitions (256 dimensional vectors), a single reference, full pel resolution search, 8-bit depth pixel, and l₁ norm, e.g., sum of absolute difference for search metric, and the search window of ±16 resulting a data set size of 1089.

Statistical characteristics of general ME input data show input dimension distances, e.g., pixel distances, to have approximately independent identical distributions while distribution varies with different candidates, e.g., distant candidates showed higher variance than nearer ones). Therefore, p̅ and μ̅ associated with a cost function

$$\overline{Ε} = {\sum }_{{a}^{′}} \overline{μ} ( a ) \overline{p} ( a )$$

for the general ME data becomes:

$$\overline{p} = ∇ {( {E}_{λ} [ {\hat{P}}_{{‖ z ‖}_{1}} ( x ) ] )}^{M}$$

$$\overline{μ} = {E}_{λ} [ \frac{{kp}^{* ( k - 1 ) * ( p μ )}}{{p}^{{ }^{{ }^{* k}}}} ] .$$

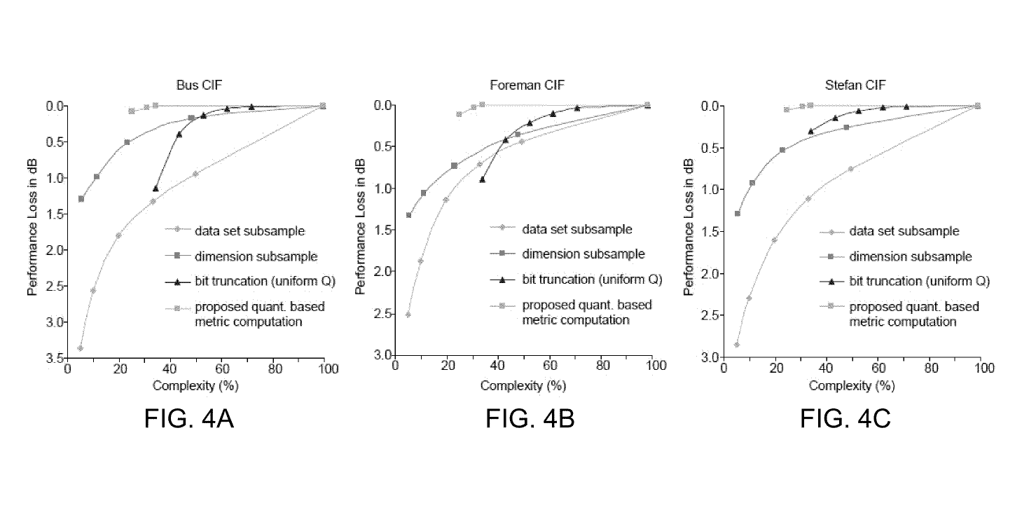

FIGS. 4A, 4B, and 4C show different examples of comparisons of complexity-performance trade-offs for four different scenarios. The four scenarios show the trade-offs between complexity and performance for three different representative scenarios and a proposed distance quantization based metric computation based on the subject matter described herein. Each scenario reduces one of i) size of a data set S, ii) dimensionality of each data x ε S, iii) bit depth of each data dimension by truncating least significant bits (equally seen as uniform quantization on each data dimension), and iv) resolution of each dimension-distance via the proposed distance quantization. The X axis represents complexity percentage to that of original full computation. The Y axis represents the rate distortion (RD) performance loss measured in dB. FIGS. 4A, 4B, and 4C show performance examples based on Bus CIF, Foreman CIF, and Stefan CIF, respectively. The proposed approach provides a better trade-off and can also be used together with most of other existing algorithms to further improve the complexity reduction.

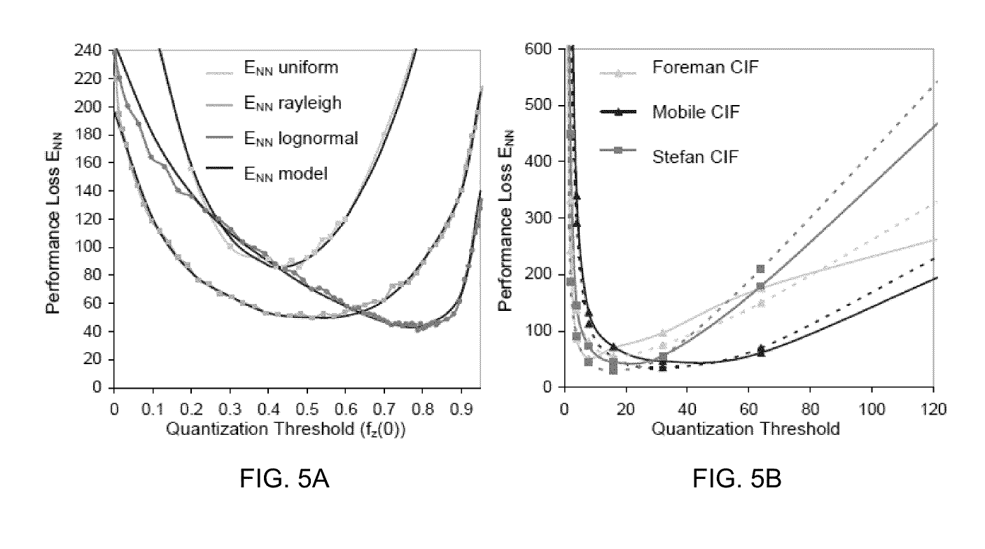

FIGS. 5A and 5B show examples of comparisons between different cost functions. FIGS. 5A shows comparisons of different cost functions such as Ē_{NN} uniform, rayleigh, log normal, and model with the expected performance error collected from numerically simulated experiments for different input distribution settings f_{y}. As the number of experiments increases, expected error converges the cost function, confirming the accuracy of the Ē formulation. FIGS. 5B shows comparisons of cost functions based on the collected ME data with simulated experiments for CIFs including Foreman CIF, Mobile CIF, and Stefan CIF.

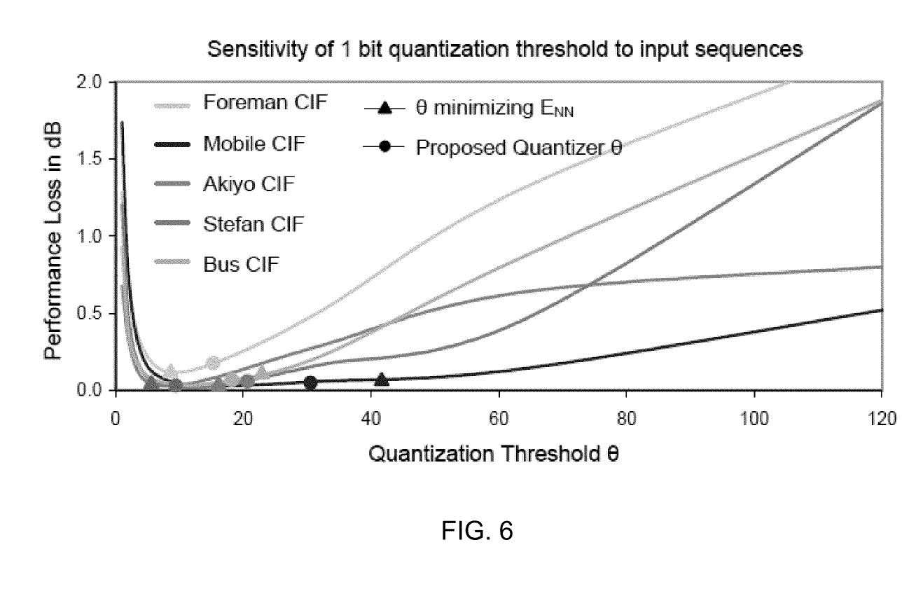

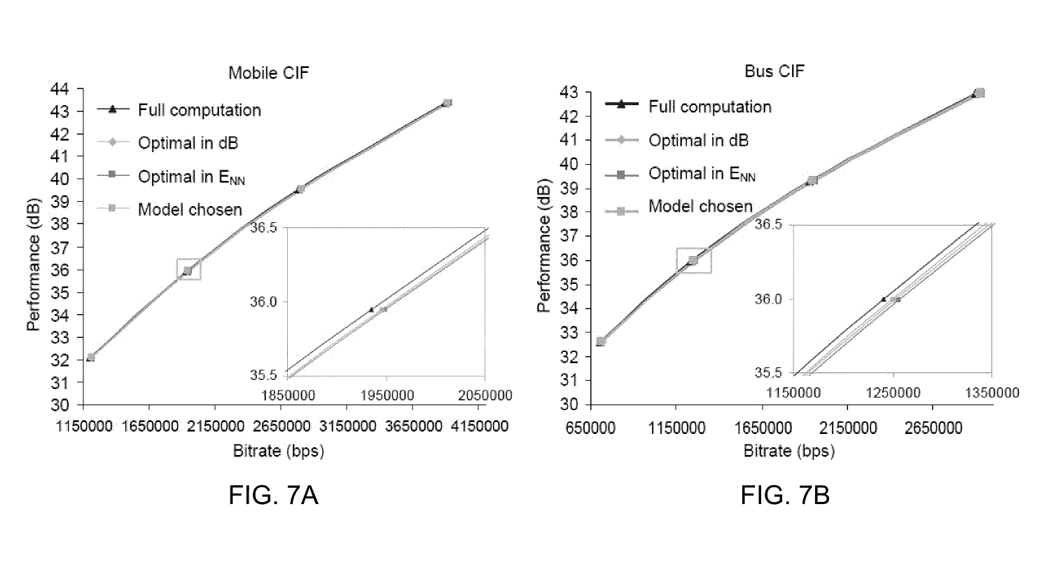

FIG. 6 and FIGS. 7A and 7B compare the performances of at least one implemention of the described subject matter with three different thresholds each of which minimizes overall coding efficiency, Ē_{NN} measure, and a cost model. FIG. 6 shows examples of different techniques performances as a function of quantization thresholds. FIGS. 7A and 7B show examples of different techniques performances as a function of bitrate. These results show that quantizers obtained by optimizing a cost function described herein can achieve near optimal performance. FIG. 6 also provides some insight about the sensitivity of optimal threshold to input variation. Despite large variation of the input source characteristics, dimension-distances where quantization is applied exhibit more consistent statistical behavior.

Some implementations can compress a search metric computation resolution by applying non-uniform scalar quantization, based on one or more query points, to candidate points prior to a metric computation summation process. Potential advantages of such implementations include removing certain computationally expensive arithmetic operations completely and can reduce the complexity of the rest of arithmetic operations significantly, complexity does not increase with the order of 1ₚ norm, and, most importantly, the penalty to be paid in performance for the complexity reduction is surprisingly quite small if designed optimally. In some implementations, quantization at the output of each dimension-distance into 1-bit results in maximized complexity reduction yet the performance tends to be almost unchanged for many applications because dimension-distances tends to exhibit very compact low-variance statistical characteristics unlike the actual source data q, r ε S. Moreover, the search metric computation resolution can be compressed such that computational complexity reduction is maximized and its impact on nearest neighbor search result is minimized. One way of accomplishing this is to apply non-uniform scalar quantization at the output of each dimension-distance distⱼ(q,r)=|qⱼ−rⱼ|^{p} prior to the summation process.

Some implementations can determine a quantizer based on the statistical characteristic of input query data. Quantization can be used to map high rate data into lower rate data so as to minimize digital storage or transmission channel capacity requirement while preserving the essential data fidelity. While conventional optimal quantizer for compression and reconstruction purpose targets to minimize the reconstruction distortion given the input probability function, optimal quantizer embedded within the search metric computation however, has to minimize the search performance degradation cost given the input statistics. This quantization can be designed in such a way that for the given bit rate the fidelity of compressed data as a search metric measure is preserved in maximum.

Implementations of the described subject matter can include processing video data. One of the factors of video compression efficiency is how well the temporal redundancy is exploited by motion compensated prediction. Performance of the motion estimation (ME) process can relate to the video compression performance. The encoder searches for and selects the motion vector (MV) with minimum distance based on the metric d among all possible MVs. Then it performs the residual coding by encoding the difference block (prediction residual) between the original and motion compensated block. Each residual block is transformed, quantized, and entropy coded. For motion estimation case, the data set S (all reference blocks within the search range) varies largely from query to query (current block). To evaluate the techniques and systems described in this document in experimental application and compare with others, various sequences are tested using a H.264/MPEG-4 AVC baseline encoder. As it is in a typical video coding setting, 16×16 block partitions, a single reference, full pel resolution search, 8-bit depth pixel, and 1₁ norm distance for search metric were considered for ME. A search window of ±32 is used resulting in the size of data set to be 4225.

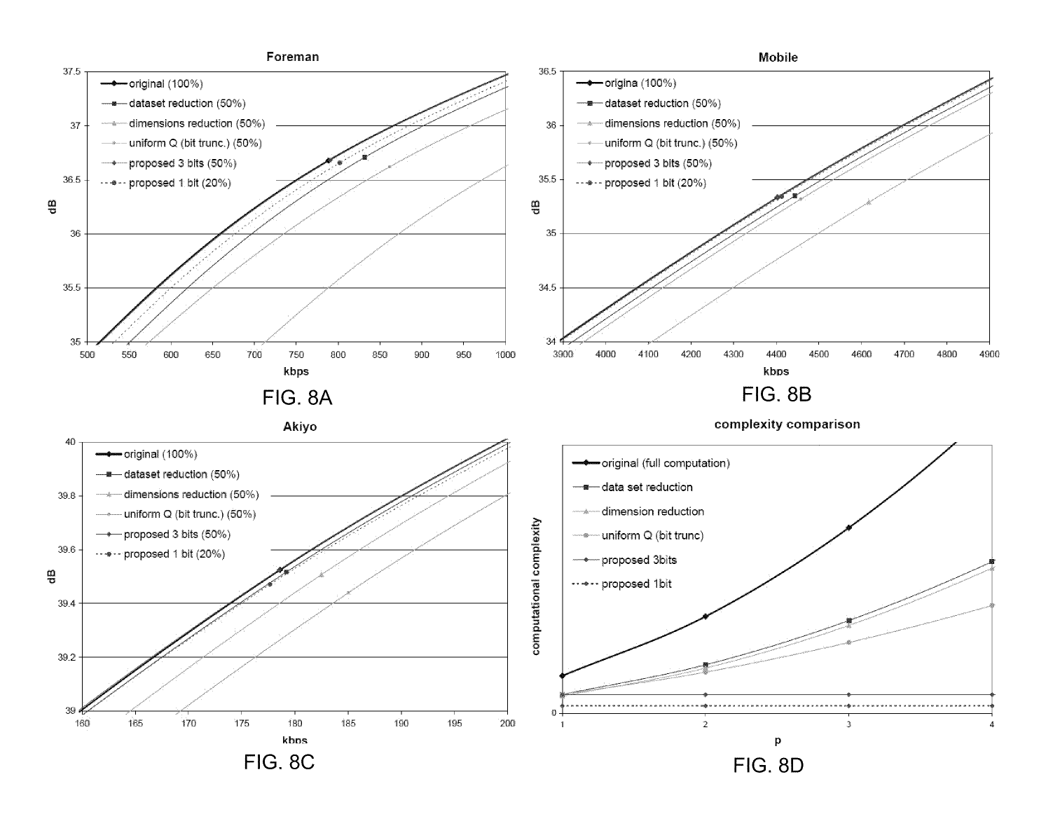

FIGS. 8A, 8B, and 8C show example performance measures for the CIF resolution Foreman, Mobile, and Akiyo sequences, respectively. In these examples, comparisons were made for total six different scenarios (as indicated in figure legend): i) full computation (benchmark approach, which compares all candidates in full resolution/dimensions), ii) data set reduction (reducing the number of candidates by a factor of two) iii) dimension reduction (subsample of dimensions into half), iv) four least significant bits truncation of both queries and candidates, v) a proposed quantization technique using 8 bins that compresses an 8-bit depth to 3-bit depth, and vi) a proposed quantization technique using 2 bins that compresses an 8-bit depth to a 1-bit depth). Their approximate complexity ratio as a percentage of the benchmark scenario is shown in parenthesis in the figure legend.

FIG. 8D shows examples of different computational complexity costs. In particular,

FIG. 8D shows the ratio of the total computational complexity cost comparing these 6 different cases over different p (the order of Minkowski metric). FIGS. 8A, 8B, and 8C represent RD performance when p is 1. Note that the thick solid line (original) is the benchmark full complexity while thin solid lines have the same complexity which is half of original case. This essentially compares the performance of four different approaches for the given equal complexity.

This document includes descriptions of a quantization based nearest-neighbor-preserving metric (QNNM) approximation algorithm. The QNNM algorithm is based on three observations: (i) the query vector is fixed during the entire search process, (ii) the minimum distance exhibits an extreme value distribution, and (iii) there is high homogeneity of viewpoints. Based on these, QNNM approximates original/benchmark metric in terms of preserving the fidelity of nearest neighbor search (NNS) rather than the distance itself, while achieving significantly lower complexity using a query-dependent quantizer. A quantizer design can be formulated to minimize an average NNS error. Query adaptive quantizers can be designed off-line without prior knowledge of the query and present an efficient and specifically tailored off-line optimization algorithm to find such optimal quantizer.

Given a metric space (U, d) with a distance/dissimilarity metric d:U×U→[0,∞), a set R ⊂ U of N objects, and a query object q ε U in (U,d), the nearest neighbor search (NNS) problem is to find efficiently the (either exact or approximate) nearest object

$${r}^{*} = {argmin}_{r} d ( q , r ) , ∀ r ∈ R . \qquad ( 1 )$$

Some NNS techniques can present serious computational challenges based on the size of data set N, the dimensionality of search space D, and the metric complexity of d. To reduce such complexity, some existing algorithms focus on how to preprocess a given data set R, so as to reduce either (i) the subset of data to be examined, by discarding a large portion of data points during the search process using efficient data structures and querying execution (e.g., variants of k-d tree, metric trees, ball-trees, or similarity hashing) and/or (ii) the dimensionality of the vectors by exploiting metric space transformations, such as metric embedding techniques or techniques based on linear transforms, e.g., principal component analysis. This document includes descriptions of techniques that reduce complexity reduction by allowing approximation within the metric computation, instead of computing the chosen distance metric to full precision. Reduction of metric computation cost has been considered only to a limited extent (e.g., simple heuristic methods such as avoiding the computation of square roots of l₂ norm, truncation of least significant bits, early stopping conditioning, etc.).

This document includes descriptions of a metric approximation algorithm which maps the original metric space to a simpler one while seeking to preserve, approximate nearest-neighbors to a given query. A metric approximation algorithm can be based on the following observations: (i) the query vector is fixed during the entire search process, (ii) when performing NNS for different queries the distances d(q, r*) between a query vector and its best match (NN) tend to be concentrated in a very narrow range (e.g., extreme value distribution of the sample minimum F^{min}(x)=Pr(d(q,r*)≦x)), and (iii) high homogeneity of viewpoints property.

The metric approximation algorithm can approximate the original metric d using a query-adaptive quantizer. For a given query q, based on Observation (i), a set of query-dependent scalar quantizers is applied to each of the components/dimensions of every candidate r ε R. The quantizer produces one integer index per dimension and the sum of these indices is used as an approximation of d(q,r). Based on Observation (ii), these quantizers can be very coarse (e.g., 1 or 2 bits per dimension) leading to very low complexity without affecting overall NNS performance. This is because we can afford to quantize coarsely the distance to candidates unlikely to be NN for a given query without affecting the outcome of the NNS. Based on Observation (iii), the problem of finding the optimal query-dependent quantization parameters can be formulated as an off-line optimization process, so that minimum complexity is required for each querying operation.

A QNNM algorithm can use a metric function d_{obj} to approximate a benchmark metric d in terms of preserving the fidelity of NNS while having significantly lower computational complexity than that of d. A metric approximation approach can be formulated as ψ:U→U_{Q} mapping the original metric space (U,d) into a simpler metric space (U_{Q},d_{Q}) where NN search is performed with d_{Q}, metric. If ψ is the same for all queries, this metric space mapping can be seen as a preprocessing (e.g., space transformation to reduce dimensionality) aiming at simplifying the metric space while preserving relative distance between objects. A query-adaptive mapping ψ_{q}:U→U_{Q} can use the information of a given query location q such that its resulting (U_{Q},d_{Q}) preserves a NN ouput, rather than relative distance between objects, without having to find the optimal ψ_{q} prior to each querying process:

$$\begin{matrix}( U , d ) {\to }^{{ψ}_{q}} ( {U}_{Q} , {d}_{Q} ) , & ( 2 ) \\ {d}_{obj} ( q , r ) = {d}_{Q} ( {ψ}_{q} ( q ) , {ψ}_{q} ( r ) ) . & ( 3 )\end{matrix}$$

Some implementations can be based on D -dimensional Euclidean space U=R^{D}.

In some implementations, each dimensional dissimilarity is measured independently and then averaged together. e.g., generalized Minkowski (Euclidean, Manhattan, weighted Minkowski etc) metric, inner product, Canberra metric, etc. For example, It can be assumed that there are no cross-interference among dimensions in original metric d, e.g., general metric function structure d can be written as:

$$d ( q , r ) = {\sum }_{j = 1}^{D} {d}_{j} ( {q}_{j} , {r}_{j} ) , r ∈ U . \qquad ( 4 )$$

An NNS algorithm accuracy can be evaluated in terms of the expected solution quality, ε̅ (closeness in terms of d metric between the original NN, r* based on d and a returned object r*_{Q} based on d_{obj} metric)

$$\overline{ɛ} = {E}_{q} ( \frac{d ( q , {r}_{Q}^{*} ( q ) ) - d ( q , {r}^{*} ( q ) )}{d ( q , {r}^{*} ( q ) )} ) . \qquad ( 5 )$$

It can be assumed that there exists a high homogeneity of viewpoints (towards nearest neighbors).

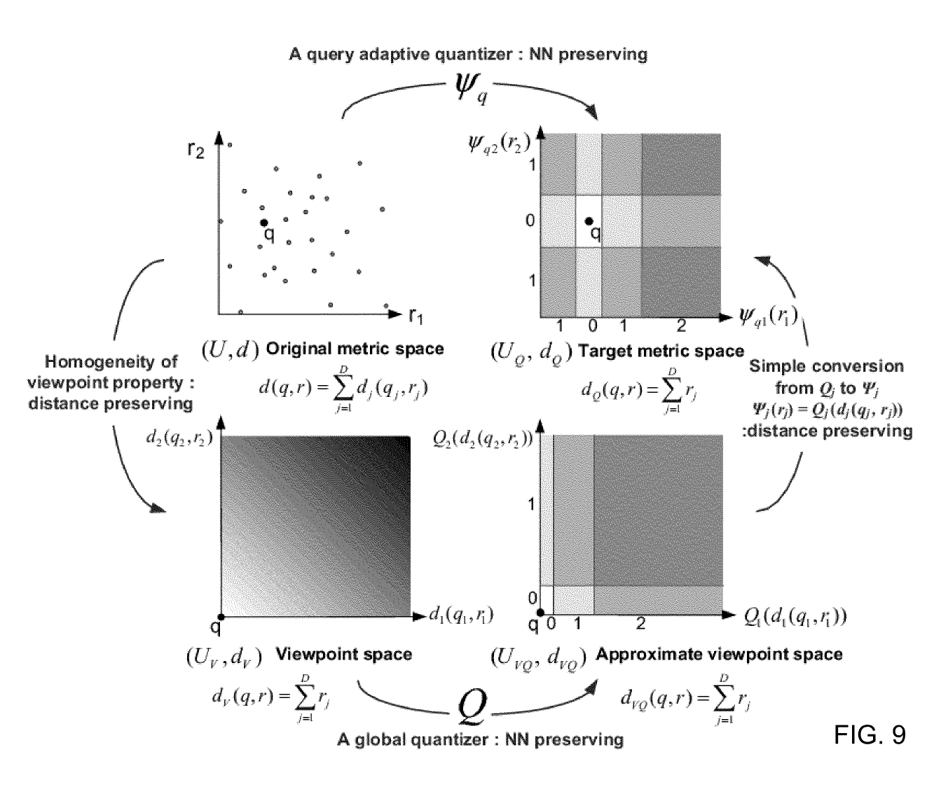

FIG. 9 shows an example of a quantization based on a nearest-neighbor-preserving metric approximation technique. FIG. 9 additionally shows the relation between ψ_{q} and Q and their related spaces. For a given query q, ψ_{q} is defined as:

ψ_{q}(r)=(ψ_{q1}(r₁),ψ_{q2}(r₂), . . . , ψ_{qD}(r_{D}), r ε U, (6)

where each ψ_{qj} is a non-uniform scalar quantizer chosen based on the query. Quantization is chosen due to its computational efficiency and flexibility to adapt to queries by simply adjusting thresholds. Since ψ_{q}(q) of Eq. (3) is constant over a searching process given q, an objective metric d_{obj} becomes a function of only ψ_{q}(r). Based on Eq. (4), d_{Q} can be formulated to be the sum of scalar quantizer outputs:

$${d}_{obj} ( q , r ) = {d}_{Q} ( {ψ}_{q} ( r ) ) = {\sum }_{j = 1}^{D} {ψ}_{qj} ( {r}_{j} ) . \qquad ( 7 )$$

Finding the optimal query-dependent ψ_{q} parameters minimizing ε̅ (5) prior to each querying operation would not be practical. However, based on the homogeneity of viewpoint property, an off-line optimization can be used to design these query-dependent quantizers. The aggregate statistics of NNS dataset/candidates in terms of their distances with respect to a query q can be very similar regardless of a query/viewpoint position. This allows to consider a viewpoint space (Uᵥ,dᵥ), where v denotes the vector of distances between a query point and a search point:

v=(d₁(q₁,r₁),d₂(q₂,r₂), . . . , d_{D}(q_{D},r_{D}))εUᵥ. (8)

Then, under the assumption of viewpoint homogeneity, we can generate off-line statistics over multiple queries and model a dataset by the an overall distance distribution Fᵥ of v in Uᵥ:

Fᵥ(x)=Pr(v≦x), (9)

where Fᵥ represents the probability that there exist objects whose distance v to a given arbitrary query is smaller than x.

Given the query-independent Fᵥ model, instead of directly finding ψ_{q}:U→U_{Q} minimizing ε̅ for every q, we could equivalently look for its analogous mapping function Q:U_{V}→U_{VQ} such that

d_{obj}(q,r)=d_{Q}(ψ_{q}(r))=d_{VQ}(Q(v)), (10)

where Q partitions the viewpoint space Uᵥ into a set of hyper-rectangular cells U_{VQ} with d_{VQ}=d_{Q}. Each dimension of U_{V} is quantized independently with Qⱼ with successive bins mapped to consecutive integer values: the bin including the origin is mapped to 0, the next one mapped to 1, etc. Each cell is therefore represented with a vector of mapping symbols z ε U_{VQ}.

z=Q(v)=(Q₁(v₁),Q₂(v₂), . . . , Q_{D}(v_{D}))ε U_{VQ}. (11)

The problem of finding the optimal ψ_{q} can be replaced by finding the optimal Q minimizing ε̅ given F_{V} because: (i) Q is query-independent which allows off-line process to find optimal Q, (ii) ε̅ of ψ_{q}:U→U_{Q} is identical to ε̅ of Q:U_{V}→U_{VQ}, and (iii) conversion from Q to ψ_{q} for a given query q is very simple: once optimal Q minimizing ε̅ is obtained off-line, given a query q prior to each querying operation, optimal ψ_{q} can be obtained by the following equation:

ψ_{qj}(rⱼ)=Qⱼ(vⱼ)=(dⱼ(qⱼ,rⱼ)), ∀ⱼ. (12)

For example, if d is l₂ norm and if we denote a quantization threshold from Qⱼ and its corresponding threshold from ψ_{qj} as θ and Θ respectively, then rⱼ≦Θ should be equivalent to vⱼ=dⱼ(qⱼ,rⱼ)=(qⱼ−rⱼ)² ≦θ, and therefore Θ=qⱼ±\sqrt{θ} A set of \sqrt{θ} needs to be obtained and stored off-line and only prior to each querying process with a given q, a set of Θ=qⱼ±\sqrt{θ} need to be computed on the fly. Note that this computation is done only once given a query q before computing any d_{obj} for all data points to identify q's NN.

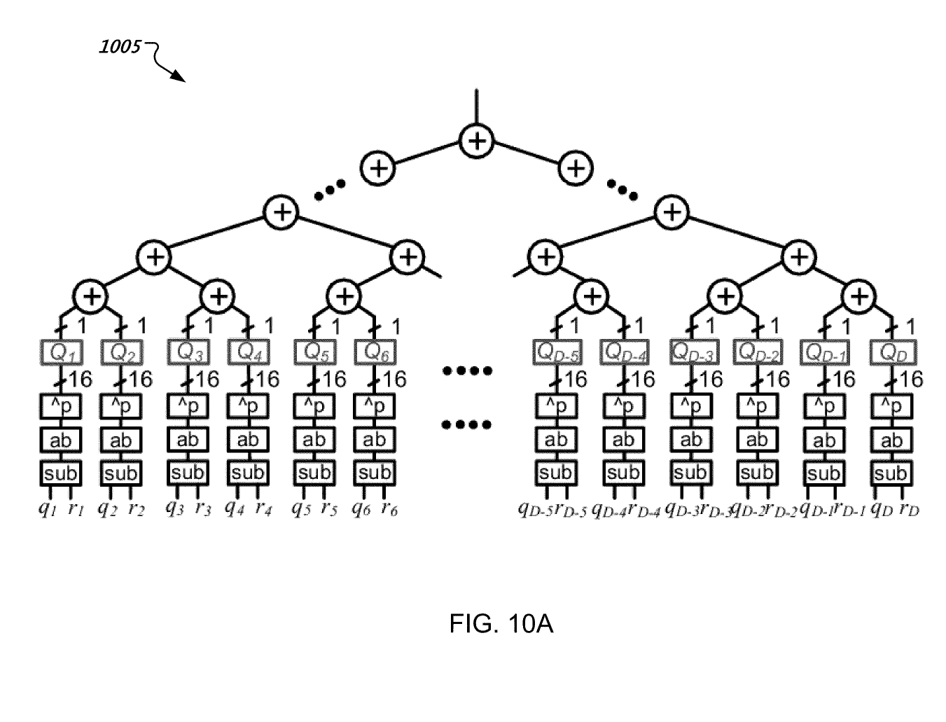

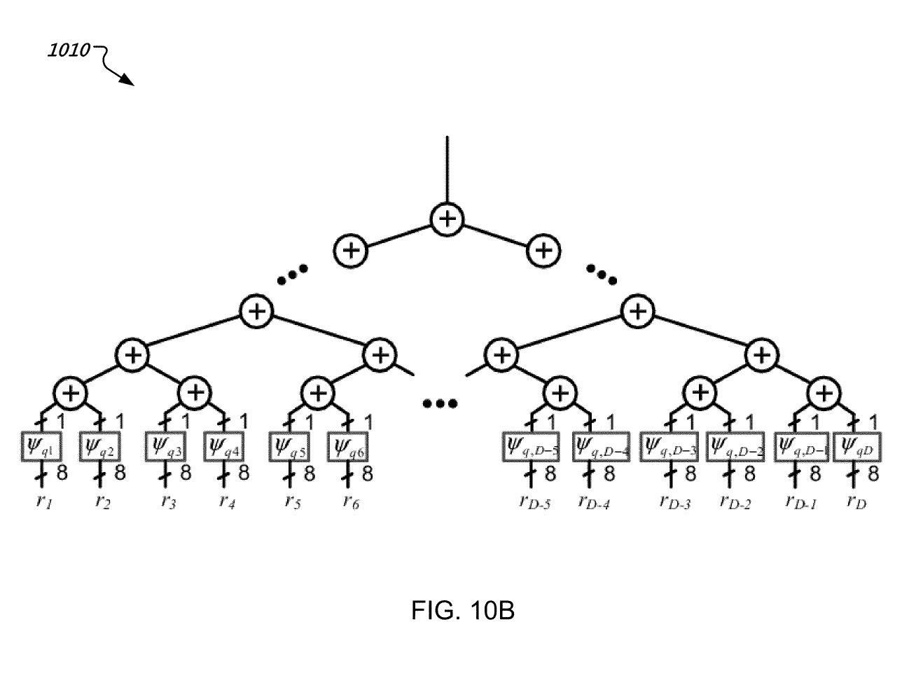

FIGS. 10A and 10B show examples of metric computation architectures that include one or more quantizers. The metric computation architecture 1005 in FIG. 10A uses a quantizer to quantize dimension-distance values. The metric computation architecture 1010 in FIG. 10B uses a quantizer to directly quantize canidate points. The quantizers in these architectures 1005, 1010 can be selected based on one or more query points.

An optimization algorithm to select the quantizer Q* that minimizes the average NNS error (5) given F_{V} as in (9) can have a form:

$${Q}^{*} = {argmin}_{Q} \{ {f}_{obj} ( Q ) := \overline{ɛ} \} . \qquad ( 13 )$$

This problem is a stochastic optimization problem with an objective function f_{obj}= ε̅. Note that in this problem we aim to optimize the quantizer to be used in NNS. Thus, in the context of this optimization, we refer to the “search” for the optimal set of quantizer parameters, which should not be confused with the search performed in NNS itself. Optimization process in general consists of two phases: the search process (e.g., generating candidate solutions) and the evaluation process (evaluating solutions, e.g., f_{obj} computation). Stochastic optimization can be computationally expensive especially due to its evaluation process, e.g., a typical Monte Carlo simulation approach (for every candidate solution, training data samples are simulated to estimate its average performance ε̅) would have a total complexity of O(TNₛ), where T is the size of training data which is sufficiently large and Nₛ is denoted as the total number of candidate solutions evaluated during the search process.

Our goal is to reduce complexity by formulating f_{obj} such that a large portion of f_{obj} computations can be shared and computed only once as a preprocessing step for a certain set of (quantizer) solution points, instead of computing f_{obj} for each solution point independently. This leads to the total optimization complexity to change from O(TNₛ) to O(T+c₁+c₂Nₛ), where c₁ and c₂ are preprocessing cost and f_{obj} evaluation cost, respectively. This requires a joint design of the search and evaluation processes.

Since only E[d(q,r_{Q}*(g))] term of ε̅ (5) changes with Q while E[d(q,r*(g))] is constant given F_{V}, f_{obj} can be reduced to:

$${f}_{obj} = E [ d ( q , {r}_{Q}^{*} ( q ) ) ] = {\sum }_{a} {μ}_{Q} ( a ) {f}_{Q}^{min} ( a ) , \qquad ( 14 )$$

where f_{Q}^{min} is the pdf of F_{Q}^{min}(a)=Pr(d_{obj}(q,r_{Q}*)≦a) and μ_{Q}(a)=E(d(q,r)|d_{obj}(q,r)=a,∀q,r εU).

Computing μ_{Q} and F_{Q}^{min} can include assigning three parameters to each cell c z of the set of hyper-rectangular cells defined by Q: (i) probability mass p_{z}, (ii) non-normalized centroid u z, and (iii) distance d_{z}=Σzⱼ. Then F_{Q}^{min} and μ_{Q}(a) are formulated as:

$$\begin{matrix}{p}_{z} = {\int }_{{c}_{z}} {f}_{V} ( v ) d v \\ {u}_{z} = {\int }_{{c}_{z}} < v , 1 > {f}_{V} ( v ) d v & ( 15 ) \\ {F}_{Q} ( a ) = {\sum }_{{d}_{z} \leq a} {p}_{z} \\ {F}_{Q}^{min} ( a ) = 1 - {( 1 - {F}_{Q} ( a ) )}^{N} & ( 16 ) \\ {μ}_{Q} ( a ) = \frac{{\sum }_{{d}_{z} = a} {u}_{z}}{{\sum }_{{d}_{z} = a} {p}_{z}} & ( 17 )\end{matrix}$$

Implementations can compute f_{obj} based on p_{z}, u_{z} for one or more cells c_{z}. However, if the following two data sets F_{V} and H_{V} are available or computed in a pre-processing stage:

$${F}_{V} ( x ) = Pr ( v \leq x ) \\ {H}_{V} ( x ) = {\sum }_{v \leq x} < v , 1 > , \qquad ( 18 )$$

then

$$Pz = {\sum }_{{z}^{′} \leq z} {p}_{{z}^{′}} and {U}_{z} = {\sum }_{{z}^{′} \leq z} {u}_{{z}^{′}}$$

can be easily computed for each cell c_{z}, so that all necessary p_{z}, u_{z} values can be obtained with only c₂=O(DN_{c}) cost. Here, N_{C} is total number of cells generated by

$$Q \cdot {N}_{C} = {\prod }_{j} ( {b}_{j} + 1 )$$

where bⱼ denotes the number of thresholds assigned by Q on j-dimension of U_{V}.

However, the computational (c₁) and storage complexity of F_{V} and H_{V} may increase exponentially (e.g., O(DW^{D}) assuming all dimensions are represented with the same resolution W). In some implementations, D is reducible depending on the input distribution F_{V} if certain dimensions are independent or interchangeable/commutative. In fact this is usually the case for real-world applications (e.g., for video coding, all pixels tend to be heavily correlated yet interchangeable statistical characteristics thus common 16×16 processing unit image block (D=256) can be reduced to D=1).

A search algorithm can maximally reuse F_{V} and H_{V} data and can update F_{V} and H_{V} in conjunction with the search process in order to reduce overall storage and computation. Observation: Given k arbitrary solution points on the search space, preprocessing cost Sₖ to build F_{V} and H_{V} containing only necessary data to compute f_{obj} of those k points is the same as that for computing f_{obj} of K different solution points which form a grid, where:

$$K = {\prod }_{j} ( \begin{matrix}( k + 1 ) {b}_{j} \\ {b}_{j}\end{matrix} ) \\ {S}_{k} = {\prod }_{j} ( {kb}_{j} + 1 ) . \qquad ( 19 )$$

In other words, if a set of solution points form a grid, they maximally reuse data from F_{V} and H_{V} and thus lead to minimal preprocessing cost in both space and time complexity. A grid based iterative search algorithm framework with guaranteed convergence to the optimal solution can be based on the above observation. A quantization parameter can be represented by a marginal cumulative probability F_{V}(θ), such that the search space becomes [0,1]^{D}. This can facilitate increasing slope, reducing neutrality, ruggedness, or discontinuity of f_{obj} function, which can increase search speed. This also provides further indication regarding to the sensitivity to performance.

A QNNM algorithm can include (i) generating a grid Gᵢ which equivalently indicates a set of solution points which correspond to all grid points, (ii) building minimum required preprocessed structures F_{Vi} and H_{Vi} for computing f_{obj} of all grid points on Gᵢ, (iii) computing a set of f_{obj} and finding its minimizer Qᵢ* of Gᵢ, and (iv) generating a next grid Gᵢ₊₁ by either moving or scaling Gᵢ based on Qᵢ* information. Implementations can model a grid G on the search space with its center/location C, grid spacing Δ, and size parameter ω, assuming it has equal spacing and size for all dimensions. Algorithm implementations can initialize a grid-size parameter ω, grid scaling rate γ, tolerance for convergence Δₜₒₗ>0, grid-spacing parameter Δ₀, and initial grid G₀. For each each iteration i=0,1, . . . , the algorithm includes performing a preprocess routine to construct F_{Vi} and H_{Vi v}to evaluate Gᵢ, a search routine to seek a minimizer Qᵢ* from Gᵢ, and an update routine to generate a new grid Gᵢ₊₁ based on Qᵢ*. The update routine can include moving the center of grid: Cᵢ₊₁=Qᵢ*. The update routine can include performing a grid space update, where for a moving grid, if Qᵢ* is on the boundary of grid Gᵢ, then Δᵢ₊₁=Δᵢ, where for a scaling grid, if Qᵢ* is not on the boundary of grid Gᵢ, then Δᵢ₊₁=Δᵢ/γ. The update routine can terminate if Δᵢ₊₁<Δₜₒₗ. The update routine can generate Gᵢ₊₁: with parameters ω, Δᵢ₊₁, and Cᵢ₊₁.

Some implementations can determine integer parameter values, w and γ, that minimize computational complexity. Optimization complexity can be quantified as

O(T+Lc₁+Lc₂Nₛ) c₁=O(Dω^{B}) c₂=O(DS₁).

Here, Nₛ depends on phase 2 grid search algorithm but roughly varies from O(ωD) to O(ωc^{D}). Here, c₁ is both time and space complexity of phase 1. L denotes the total number of iterations. Note that c₂ is fixed regardless of w and γ. Overall complexity can be reduced from O(L(T+c₁+c₂Nₛ)) to O(T+Lc₁+Lc₂Nₛ) by splitting and deleting portions of training data set at each iteration such that only relevant data is examined for each update. If we assume to continue iteration until it gets as fine as resolution W, total iteration number is

$$L \approx \frac{γ}{ω} {log}_{γ} \frac{W}{w} .$$

Therefore, γ≧1 minimizing γ log_{γ} W and minimum possible integer ω≧2 can minimize overall complexity in both time and space, e.g., γ=3 and ω=2.

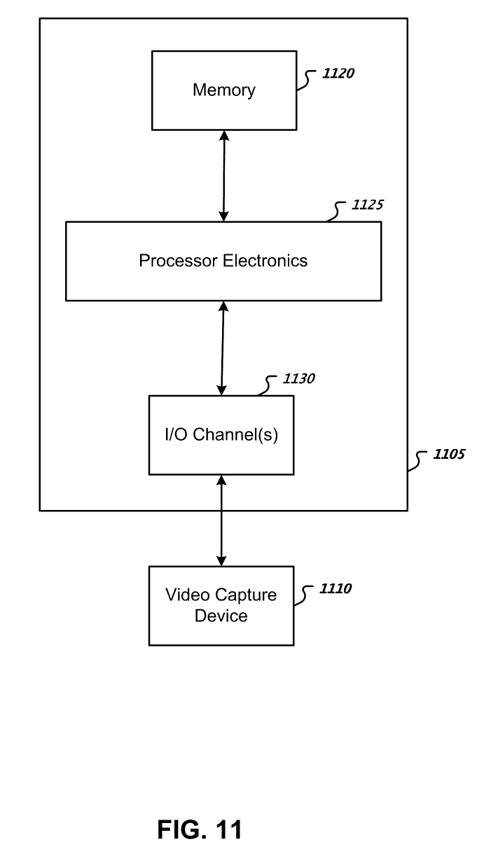

FIG. 11 shows an example of a system configured to perform non-uniform quantized based metric computations. A system can include a processing apparatus 1105 and a video capture device 1110. The processing apparatus 1105 can receive video data from the video capture device 1110 and can process the video data. For example, a processing apparatus 1105 can perform motion estimation to compress the video data. A processing apparatus 1105 can include a memory 1120, processor electronics 1125, and one or more input/output (I/O) channel 1130 such as a network interface or a data port such as a Universal Serial Bus (USB). Memory 1120 can include random access memory. Processor electronics 1125 can include one or more processors. In some implementations, processor electronics 1125 can include specialized logic configured to perform quantized based metric computations. An input/output (I/O) channel 1130 can receive data from the video capture device 1110. A processing apparatus 1105 can be implemented in one or more integrated circuits. In some implementations, memory 1120 can store candidate points. In some implementations, memory 1120 can store processor instructions associated with a quantized based metric process.

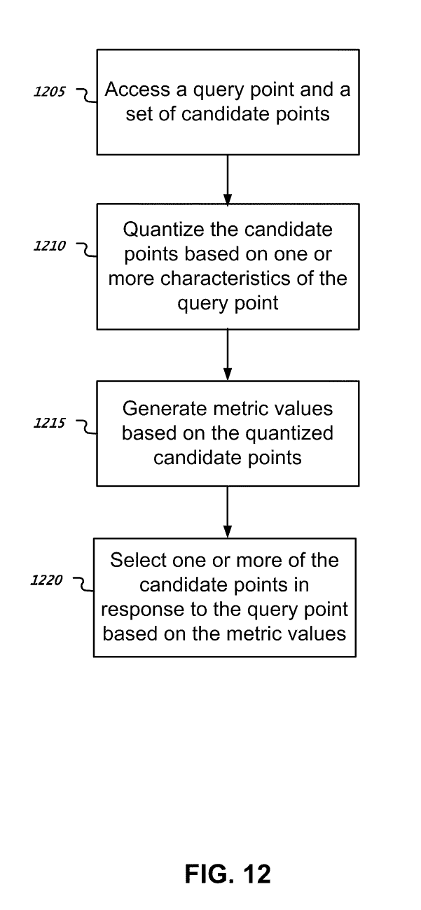

FIG. 12 shows an example of a process that includes non-uniform quantized based metric computations. The process can access a query point and a set of candidate points (1205).

The process can quantize the candidate points based on one or more characteristics of the query point (1210). The process can generate metric values based on the quantized candidate points (1215). In some implementations, the metric values are indicative of respective proximities between the query point and the candidate points. The process can select one or more of the candidate points in response to the query point based on the metric values (1220).

In some implementations, the precision level of a distance measure can be taken into account for complexity reduction. Some implementations can alter the metric computation precision by compressing the search metric computation resolution through applying non-uniform scalar quantization within the metric computation process. Quantization of the output of a dimension-distance, such as |qⱼ−rⱼ|^{p}, can reduce complexity. Quantization can reduce the bit-depth of each dimension-distance output which leads to a significant complexity reduction in its following process (a tree of k−1 summations and 1/p-th power computation). A quantizer can be implemented in such a way that the input dimension-distance computation |qⱼ−rⱼ|^{p} does not have to be computed at all. In some implementations, the quantizer thresholds are fixed over queries and query vector q is also constant over searching many different candidate points r, thus only r is varying. Therefore r can be quantized directly and have the same result without having to compute |qⱼ−rⱼ|^{p} first and then to apply the quantization.

In some implementations, approximations of one or more quantizers can be used to minimize circuit complexity. Quantization can be query dependent, e.g., each query uses a different quantization. Some implementations can use reconfigurable hardware. For example, some implementations can reconfigure one or more portions of a system before processing a query. Some implementations can use circuitry that takes query q and candidate r as inputs and would approximate the quantization output of the optimized quantizer with minimal circuit complexity.

A few embodiments have been described in detail above, and various modifications are possible. The disclosed subject matter, including the functional operations described in this document, can be implemented in electronic circuitry, computer hardware, firmware, software, or in combinations of them, such as the structural means disclosed in this document and structural equivalents thereof, including potentially a program operable to cause one or more data processing apparatus to perform the operations described (such as a program encoded in a computer storage medium, which can be a memory device, a storage device, a machine-readable storage substrate, or other physical, machine-readable medium, or a combination of one or more of them).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this document contains many specifics, these should not be construed as limitations on the scope of any invention or of what may be claimed, but rather as descriptions of features that may be specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this document.

What is claimed is:

1. A method performed by data processing apparatus, comprising:
quantizing a set of candidate points based on one or more characteristics of a query point;
generating metric values based on the quantized candidate points, respectively, the metric values being indicative of respective proximities between the query point and the candidate points; and
selecting one or more of the candidate points in response to the query point based on the metric values.

2. The method of claim 1, wherein quantizing the candidate points comprises:
accessing non-uniform intervals based on the query point, each non-uniform interval being described by one or more threshold values and associated with a range of inputs and an output; and
quantizing the candidate points based on non-uniform intervals.

3. The method of claim 2, wherein the query point and the candidate points comprise elements that correspond to respective dimensions, wherein quantizing the candidate points comprises:
using different sets of non-uniform intervals, associated with respective different ones of the dimensions, to quantize the dimensional elements of the candidate points, each set of non-uniform intervals selected based on a respective element of the query point.

4. The method of claim 3, wherein generating metric values based on quantized candidate points comprises: summing quantized elements of a quantized candidate point to produce a metric value.

5. The method of claim 1, comprising:
determining one or more quantizers that preserve distance ranking between the query point and the candidate points, wherein quantizing the candidate points based on one or more characteristics of the query point comprises using the one or more quantizers.

6. The method of claim 5, wherein quantizing the candidate points based on one or more characteristics of the query point comprises using different quantizers, associated with different dimensions, to quantize elements.

7. The method of claim 5, wherein determining one or more quantizers comprises:
determining a number of quantization levels, one or more quantization threshold values, and mapping values for one or more dimensions.

8. The method of claim 1, comprising:
determining one or more statistical characteristics of multiple, related, query points, wherein the query points comprise elements that correspond to respective dimensions; and
determining one or more quantizers based on the one or more statistical characteristics, each quantizer corresponding to at least one of the dimensions and operable to generate a quantized output based on an input.

9. The method of claim 8, wherein quantizing the candidate points based on one or more characteristics of the query point comprises using the one or more quantizers.

10. The method of claim 8, wherein determining one or more quantizers comprises determining a quantizer that maps successive bins of input values to respective integer values.

11. The method of claim 8, wherein determining one or more quantizers comprises determining threshold values that delineate non-uniform quantization intervals based on an iterative process that minimizes a nearest neighbor search measure.

12. The method of claim 1, comprising:
performing motion estimation based on information comprising the selected one or more candidate points.

13. A method performed by data processing apparatus, comprising:
accessing a set of candidate points from a memory; and
operating processor electronics to perform operations based on the set of candidate points with respect to a query point to produce values being indicative of respective proximities between the query point and the candidate points, and use the values to determine a nearest neighbor point from the set of candidate points, wherein the computations include applying non-uniform quantizations based on one or more characteristics of the query point.

14. The method of claim 13, wherein applying non-uniform quantizations comprises quantizing the candidate points based on non-uniform intervals, wherein the non-uniform intervals are described by a set of threshold values that are based on the query point, wherein each one of the quantized candidate points comprises quantized elements corresponding to a plurality of dimensions.

15. The method of claim 14, wherein operating processor electronics to perform operations comprises operating processor electronics to sum quantized elements of a corresponding one of the quantized candidate points to produce a corresponding one of the values.

16. The method of claim 14, wherein the query point comprises elements corresponding to a plurality of dimensions, wherein each one of the candidate points comprises elements corresponding to the plurality of dimensions,
wherein operating processor electronics to perform operations comprises operating processor electronics to generate, for two or more of the dimensions, a partial distance term that is indicative of a distance between corresponding elements of the query point and each one of the candidate points.

17. The method of claim 16, wherein operating processor electronics to perform operations comprises operating processor electronics to quantize the partial distance terms based on the non-uniform intervals.

18. The method of claim 17, wherein operating processor electronics to perform operations comprises operating processor electronics to determine a metric value based on a summation of the quantized partial distance terms associated with the each one of the candidate points.

19. The method of claim 17, wherein the partial distance terms respectively comprise dimension-distance terms, wherein the quantizing reduces a bit-depth of each dimension-distance term.

20. A computer storage medium encoded with a computer program, the program comprising instructions that when executed by data processing apparatus cause the data processing apparatus to perform operations comprising:
quantizing a set of candidate points based on one or more characteristics of a query point;
generating metric values based on the quantized candidate points, respectively, the metric values being indicative of respective proximities between the query point and the candidate points; and
selecting one or more of the candidate points in response to the query point based on the metric values.

21. The medium of claim 20, wherein quantizing the candidate points comprises:
accessing non-uniform intervals based on the query point, each non-uniform interval being described by one or more threshold values and associated with a range of inputs and an output; and
quantizing the candidate points based on non-uniform intervals.

22. The medium of claim 21, wherein the query point and the candidate points comprise elements that correspond to respective dimensions, wherein quantizing the candidate points comprises:
using different sets of non-uniform intervals, associated with respective different ones of the dimensions, to quantize the dimensional elements of the candidate points, each set of non-uniform intervals selected based on a respective element of the query point.

23. The medium of claim 22, wherein generating metric values based on quantized candidate points comprises: summing quantized elements of a quantized candidate point to produce a metric value.

24. The medium of claim 20, wherein the operations comprise:
determining one or more quantizers that preserve distance ranking between the query point and the candidate points, wherein quantizing the candidate points based on one or more characteristics of the query point comprises using the one or more quantizers.

25. The medium of claim 24, wherein quantizing the candidate points based on one or more characteristics of the query point comprises using different quantizers, associated with different dimensions, to quantize elements.

26. The medium of claim 24, wherein determining one or more quantizers comprises: determining a number of quantization levels, one or more quantization threshold values, and mapping values for one or more dimensions.

27. The medium of claim 20, wherein the operations comprise:
determining one or more statistical characteristics of multiple, related, query points, wherein the query points comprise elements that correspond to respective dimensions; and
determining one or more quantizers based on the one or more statistical characteristics, each quantizer corresponding to at least one of the dimensions and operable to generate a quantized output based on an input.

28. The medium of claim 27, wherein quantizing the candidate points based on one or more characteristics of the query point comprises using the one or more quantizers.

29. The medium of claim 27, wherein determining one or more quantizers comprises determining a quantizer that maps successive bins of input values to respective integer values.

30. The medium of claim 27, wherein determining one or more quantizers comprises determining threshold values that delineate non-uniform quantization intervals based on an iterative process that minimizes a nearest neighbor search measure.

31. The medium of claim 20, wherein the operations comprise:
performing motion estimation based on information comprising the outputted one or more candidate points.

32. A system, comprising:
a memory configured to store data points, wherein the data points comprise elements that correspond to respective dimensions; and
processor electronics configured to access a query point, use one or more of the data points as candidate points, use one or more quantizers to quantize the candidate points based on one or more characteristics of the query point, generate metric values based on the quantized candidate points, respectively, the metric values being indicative of respective proximities between the query point and the candidate points, select one or more of the candidate points, based on the metric values, as an output to the query point.

33. The system of claim 32, wherein the processor electronics are configured to access non-uniform intervals based on the query point, each non-uniform interval being described by one or more threshold values and associated with a range of inputs and an output, and quantize the candidate points based on non-uniform intervals.

34. The system of claim 33, wherein the query point and the candidate points comprise elements that correspond to respective dimensions, wherein the processor electronics are configured to use different sets of non-uniform intervals, associated with respective different ones of the dimensions, to quantize the dimensional elements of the candidate points, each set of non-uniform intervals selected based on a respective element of the query point.

35. The system of claim 34, wherein the processor electronics are configured to sum quantized elements of a quantized candidate point to produce a metric value.

36. The system of claim 32, wherein the processor electronics are configured to determine the one or more quantizers to preserve distance ranking between the query point and the candidate points.

37. The system of claim 36, wherein the processor electronics are configured to use different quantizers, associated with different dimensions, to quantize elements.

38. The system of claim 36, wherein determining the one or more quantizers comprises determining a number of quantization levels, one or more quantization threshold values, and mapping values for one or more dimensions.

39. The system of claim 32, wherein the processor electronics are configured to determine one or more statistical characteristics of multiple, related, query points, wherein the query points comprise elements that correspond to respective dimensions and determine one or more quantizers based on the one or more statistical characteristics, each quantizer corresponding to at least one of the dimensions and operable to generate a quantized output based on an input.

40. The system of claim 39, wherein determining the one or more quantizers comprises determining a quantizer that maps successive bins of input values to respective integer values.

41. The system of claim 39, wherein determining the one or more quantizers comprises determining threshold values that delineate non-uniform quantization intervals based on an iterative process that minimizes a nearest neighbor search measure.

42. The system of claim 32, wherein the processor electronics are configured to perform motion estimation based on information comprising the outputted one or more candidate points.
